(19) United States
(12) Patent Application Publication
(10) Pub. No.: US 2003/0071121 A1
(43) Pub. Date: Apr. 17, 2003

(54) Optical data collection device with a combined targeting and focusing apparatus

(76) Inventor: Gregg R. Kricorissian, Ottawa (CA)

Correspondence Address: PEARNE & GORDON LLP, 526 SUPERIOR AVENUE EAST, SUITE 1200, CLEVELAND, OH, 44114-1484, US

(21) Appl. No.: 09/976,350

(22) Filed: Oct. 12, 2001

(51) Int. Cl. G06K 7/10; G06K 7/14

(52) U.S. Cl. 235/454

(57) ABSTRACT

An optical reader for collecting image data representative of light reflected from a target which may be a symbology and a method of collecting data are described. The optical reader comprises an imager having a photosensitive detector for producing image data signals from light reflected by the target and a system for focusing the reflected light onto the photosensitive detector from the target located within a depth of reading range of the imager, as well as a targeting generator for generating an illuminated pattern on the target such that the pattern appears substantially in focus on the target located over a range of distances from the generator within the depth of reading range of the imager. The photosensitive detector may include charge coupled devices or complementary metal oxide silicon devices. The targeting generator may comprise one or more generators mounted about the imager to project a predetermined pattern along an optical axis. Each generator may include a light source for producing a coherent beam, a diffractive surface for producing a pattern from the coherent beam and an element for focusing the pattern in the depth of reading range of the imager. The focusing element may be a fresnel lens and the diffractive surface may be a diffractive optical element or a diffractive optical element on the surface of the fresnel lens facing the light source. Various arrangements of targeting generators are possible.

### FIELD OF THE INVENTION

The invention relates generally to readers for collecting optical image data and decoding a symbology contained within the image data and more particularly to a focusing aid for the reader.

### BACKGROUND OF THE INVENTION

Optical readers have been developed to read a symbology that is typically marked on the surface of an article. The symbology contains encoded data represented as light and dark regions arranged in a one-dimensional pattern or with a greater data density in a two-dimensional pattern.

An operator aligns the optical reader with the target containing the targeted symbology and the reader optically senses the light reflected from different parts of the target using a photosensitive detector and processes the intensity information to determine the encoded data. In one configuration, a laser beam is scanned over the target and a photosensitive detector records the intensity of the reflected laser beam and then decodes the encoded data of the symbology in the target from the variations in intensity of the reflections. To cover the whole target of a two-dimensional symbology, the laser is scanned in a raster pattern. In another configuration, the target is illuminated and a photosensitive detector captures an image of the target then processes the image to determine the encoded data of the symbology in the target. The latter configuration is typically faster, more versatile and can be used for the dual purposes of capturing an image of any target such as a graphics, an illustration, a picture or a symbology, and of reading a symbology if contained within the image.

For ease of use by the operator, the reader must be able to decode symbologies that are located in a range of distances relative to the reader. When using a photosensitive detector, the light reflected from the target needs to be focused onto the photosensitive detector to produce an acceptable image of the symbology so that it can be successfully decoded. The focusing system is designed to produce an acceptable image of targets in a range of distances from the reader referred to as the depth of field with the central point of the depth of field referred to as the focal plane of the reader. When the target is not within the depth of field of the reader, the focusing system can be adjusted to a new focal plane such that the target is located within the new depth of field of the reader. Alternatively, an aid can be provided that helps the operator to place the target within the depth of field of a reader that has a fixed focusing system.

The former method is used in U.S. Pat. No. 5,841,121, which issued to Koenck on Nov, 24, 1998, where a reader is disclosed that measures the distance from the reader to the target then adjusts the focusing system based on the distance measurement to produce a sharp image of the target. The distance measurement and adjustable focusing system yields a larger range of distances where a sharp image is produced but is more costly to implement, complicated and bulky compared to a fixed focusing system.

In U.S. Pat. No. 6,065,678, which issued to Li et al on May 23, 2000, a reader is disclosed that uses a fixed focusing system along with an aid to help the operator place the target within the depth of field of the reader. The aid consists of an optical pattern that is projected onto the target area and forms a single pattern when the target is at the focal plane of the imager but projects a split image when not at this position. The invention requires the accurate alignment of four mirrors and a laser diode in the reader housing. To produce an accurate focusing aid the mirrors need to be placed over a wide distance which is undesirable in the limited area of a compact reader. This system only indicates the focal plane of the reader to the operator and does not indicate the depth of field so the operator is unaware of the range of acceptable distances between the reader and the target.

In U.S Pat. No. 5,949,057, which issued to Feng on Sep. 7, 1999, a reader with a fixed focusing system is also disclosed and uses two light sources to produce two patterns that overlap to form a single pattern at the focal plane of the reader. A wide area in the reader is also needed for this system and the depth of field is also not indicated to the operator.

Therefore, there is a need for a compact focusing aid for a reader with a fixed focusing system for indicating the proper reading position of the reader to the operator.

### SUMMARY OF THE INVENTION

The invention is directed to an optical reader for collecting image data representative of light reflected from a target. The optical reader comprises an imager having a photosensitive detector for producing image data signals from light reflected by the target and a system for focusing the reflected light onto the photosensitive detector from the target located within a depth of reading range of the imager, as well as a targeting generator for generating an illuminated pattern on the target such that the pattern appears substantially in focus on the target located over a range of distances from the generator within the depth of reading range of the imager. The photosensitive detector may include charge coupled devices or complementary metal oxide silicon devices.

In accordance with another aspect of the invention, the optical reader further includes an image processor for receiving the image data signals and decoding information contained in the image. The optical reader may further include a host connection for receiving either the decoded information or the image data signals directly for transfer to a host system. The image in either case may contain a symbology.

In accordance with a further aspect of this invention, the optical reader may further comprise an illumination system for illuminating the target area and a controller for controlling the imager, the target generator, the host connection and the illumination system.

In accordance with another aspect of the invention, the targeting generator may comprise one or more targeting generators fixedly mounted about the imager wherein each targeting generator is adapted to project a predetermined pattern along an optical axis. Specifically, two targeting generators may be mounted about the imager such that the optical axes of the targeting generators are parallel and coplanar with the optical axis of the imager. Alternately, one targeting generator may be mounted about the imager such that the optical axis of the targeting generator is parallel to the optical axis of the imager. In the latter case, the optical axis of the targeting generator may intersect with the optical axis of the imager in the depth of reading range of the imager.

In accordance with a further aspect of this invention, the targeting generator may comprise a light source for producing a coherent beam, a diffractive surface for producing a pattern from the coherent beam and an element for focusing the pattern in the depth of reading range of the imager. The focusing element may be a fresnel lens and the diffractive surface may be a diffractive optical element standing alone or as a surface on the fresnel lens facing the light source. The light source may be a laser diode or a HeNe laser.

In accordance with a further aspect of this invention, the optical reader for collecting image data of a target may comprise an imager having a photosensitive detector for producing image data signals from light reflected by the target, a system for focusing the reflected light from the target onto the photosensitive detector, and a targeting generator adapted to project a substantially in focus illuminated pattern onto the target when located at a predetermined range of distances from the target for positioning the optical reader relative to the target. The imager has a predetermined depth of reading range and the illuminated pattern is substantially in focus when the target is located within the predetermined depth of reading range. The optical reader may further include an image processor for receiving the image data signals and decoding information contained in the image. The predetermined depth of reading range is determined by the focusing system and the image processor.

In accordance with another aspect of this invention, the method of sensing and collecting optical image data of a target using a reader having an imager with a predetermined depth of reading range, a targeting generator for projecting one or more illuminated patterns on the target wherein the pattern is substantially in focus at a distance within the predetermined depth of reading range of the imager, a host connection for receiving the image data for transfer to a host system, target illumination system and a controller for controlling the imager, the target generator and the illumination system, comprises energizing the targeting generator, adjusting the reader position, capturing the target image and sending the image data to the host connection means for transfer. The process may further include illuminating the target while the target generator is energized or after it has been de-energized.

Further in accordance with the present invention, the method of sensing and collecting optical image data of a target using a reader having imager with a predetermined depth of reading range comprises projecting one or more illuminated patterns on the target wherein the pattern is substantially in focus ata distance within the predetermined depth of reading range, adjusting the distance between the reader and the target until the pattern is substantially in focus and capturing the image of the target.

In accordance with a specific aspect of the present method, patterns may be projected at the target such that they are equally spaced about the imager optical axis, or a pattern may be projected on the imager optical axis. In addition, the rotational position of the reader with respect to the target may be adjusted. The target may be a symbology, a picture with a symbology embedded therein, a one-dimensional or a two-dimensional symbology. However, the target need not be a symbology, it could just be a scene that is to be imaged. The patterns may be arrows rectangles, crosses, circles or a horizontal line with a vertically elongated diamond at its centre.

In accordance with another aspect of this invention, the method of sensing and collecting optical image data of a symbology using a reader having an imager with a predetermined depth of reading range, a targeting generator for projecting one or more illuminated patterns on the target wherein the pattern is substantially in focus at a distance within the predetermined depth of reading range of the imager, an image processor for receiving the symbology optical image data and decoding information contained in the symbology, host connection for receiving the decoded information for transfer to a host system, a target illumination system, and a controller for controlling the imager, the target generator, the image processor and the illumination system, comprises energizing the targeting generator, adjusting the reader position, capturing the symbology image and decoding the symbology image. The process may further include illuminating the symbology while the target generator is energized or after it has been de-energized. The process may be repeated until the symbology is successfully decoded.

In accordance with another aspect of this invention, the method of sensing and collecting optical image data of a target using a reader having an imager with a predetermined depth of reading range, a targeting generator for projecting one or more illuminated patterns on the target wherein the pattern is substantially in focus at a distance within the predetermined depth of reading range of the imager, a host connection for receiving the image data for transfer to a host system, target illumination system and a controller for controlling the imager, the target generator and the illumination system, comprises energizing the targeting generator, adjusting the reader position, capturing the target image and sending the image data to the host connection means for transfer. The process may further include illuminating the target while the target generator is energized or after it has been de-energized.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a schematic block diagram of the components of a reader;

FIG. 2 is a flowchart showing the steps for reading a symbology;

FIG. 3 is a flowchart showing the steps for capturing an image using a reader;

FIG. 4 is a sectional view of a focusing targeting generator according to the present invention;

FIG. 5 is a preferred embodiment of the present invention;

FIG. 6 is the projected targeting patterns next to a symbology; and

FIG. 7 is a second embodiment of the present invention.

### DETAILED DESCRIPTION OF THE INVENTION

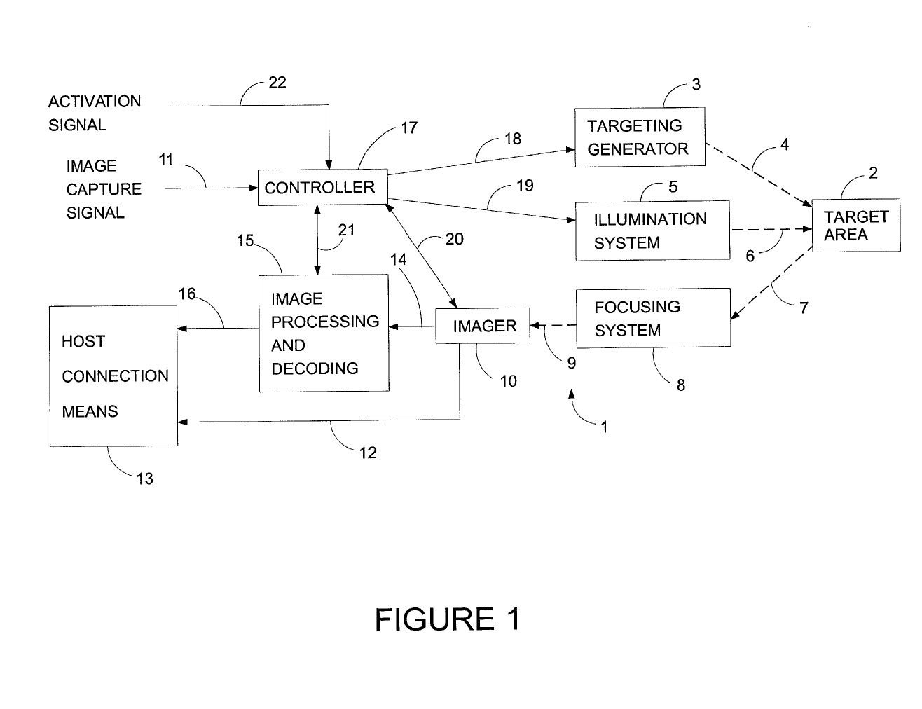

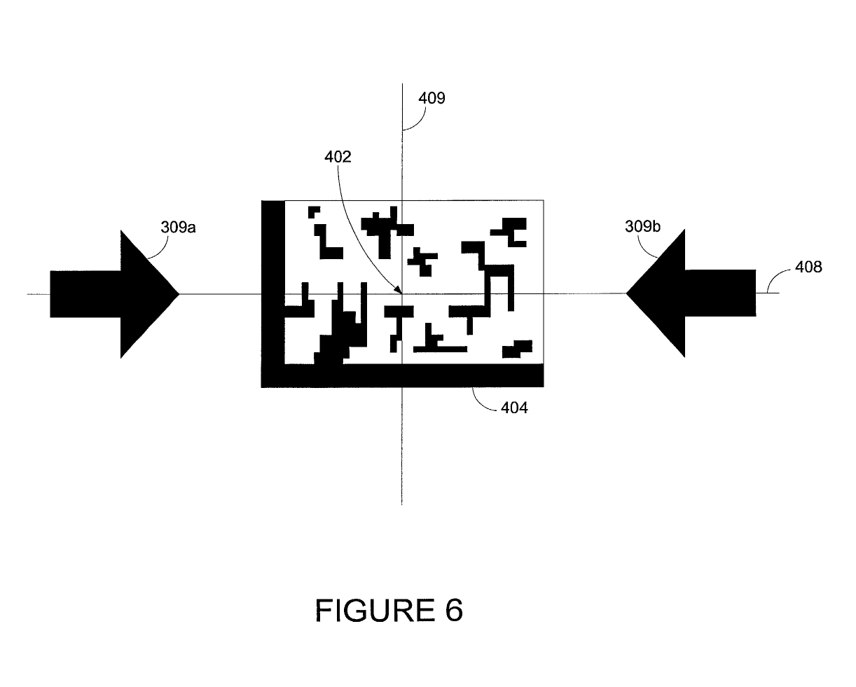

Referring to the block diagram in FIG. 1, the main components of an optical reader 1 are shown with a target 2, as well as the communication paths between the components in the reader 1 and between the reader 1 and the target 2. An operator aligns the reader 1 with the target 2 for the purpose of imaging a portion of or the entire target 2. The target 2 may be a graphics, a picture, or some other form of illustration to be simply captured or a symbology type of target that contains encoded data in either a one-dimensional configuration or two-dimensional configuration to be captured and decoded. One-dimensional configuration symbologies may be of the type known as bar-codes, while two-dimensional symbologies may be of the type illustrated in FIG. 6.

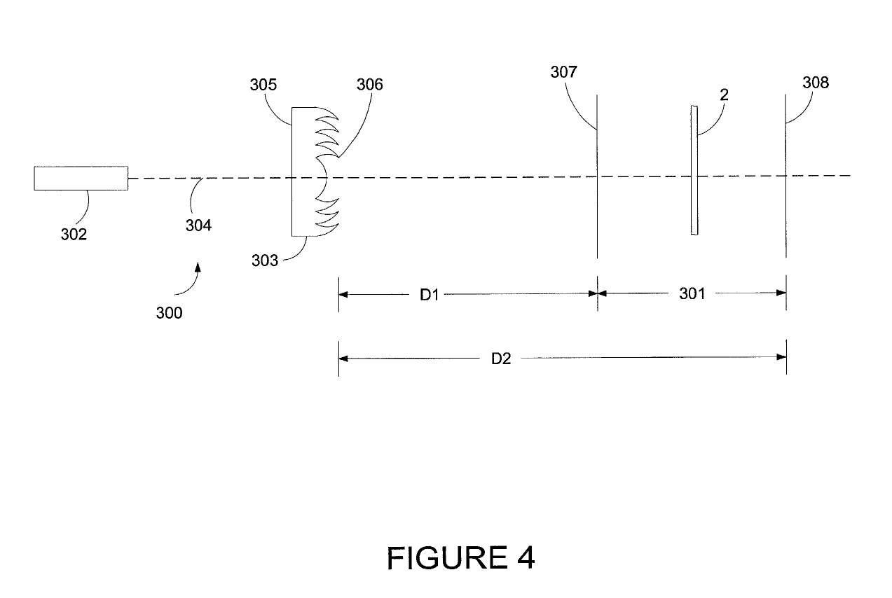

To guide an operator such that the reader 1 is the correct distance away from the target 2, a targeting generator 3 projects a pattern onto the target 2 along path 4. The projected pattern also helps an operator align the reader 1 with the target 2. A targeting generator 3 and the alignment with the other components of the reader are further detailed in the discussion of FIGS. 4 to 7.

The reader 1 may include an illumination system 5 to provide illumination on the target 2 shown as path 6. Ambient lighting from sources external to the reader 1 may provide the entire or additional illumination on the target 2. The illumination from the illumination system 5 and/or the ambient light sources is reflected from the target 2 along path 7 to the focusing system 8 contained within the reader 1. The focusing system 8 contains optics to focus the total reflected illumination onto the imager 10 via path 9.

The imager 10 comprises a photosensitive detector that produces image data signals that are descriptive of the total reflected illumination from the target 2 and focused by the light focusing system 8. By way of example, the photosensitive detector can be implemented using a charge coupled device (CCD) or a complementary metal oxide silicon (CMOS) imaging device arranged in a linear or two-dimensional configuration.

Depending on the type of image being captured, an operator can choose to transfer the image data from the imager 10 via path 12 directly to a host connection means 13 or to process and decode the image in the image processing and decoding circuitry 15 first. Using a state changer such as a selector switch, trigger or by scanning a pre-defined symbology, the operator will select the type of operation desired, i.e. either to transfer the image data to the image processing and decoding circuitry 15 or to transfer the image data directly to the host connection means 13. The host connection means 13 may be a connection for a remote system such as an RS232 serial connection or it may be a connection for any system that will use the data such as a direct bus to a CPU. The ability to transfer the image data directly to a host system is not essential to the operation of the reader 1 but is shown to indicate a possible additional function of the reader 1.

The image capture signal 11 is used by the operator to initiate the image capture step in the reader 1.

To read a symbology located in the target 2, the image data is transferred along 14 to the image processing and decoding circuitry 15 which searches for a symbology within the image data and if one is found it is decoded to determine the information contained within the symbology. When a symbology is successfully decoded, the information from the symbology is transferred to a host system using the path 16 and the host connection means 13.

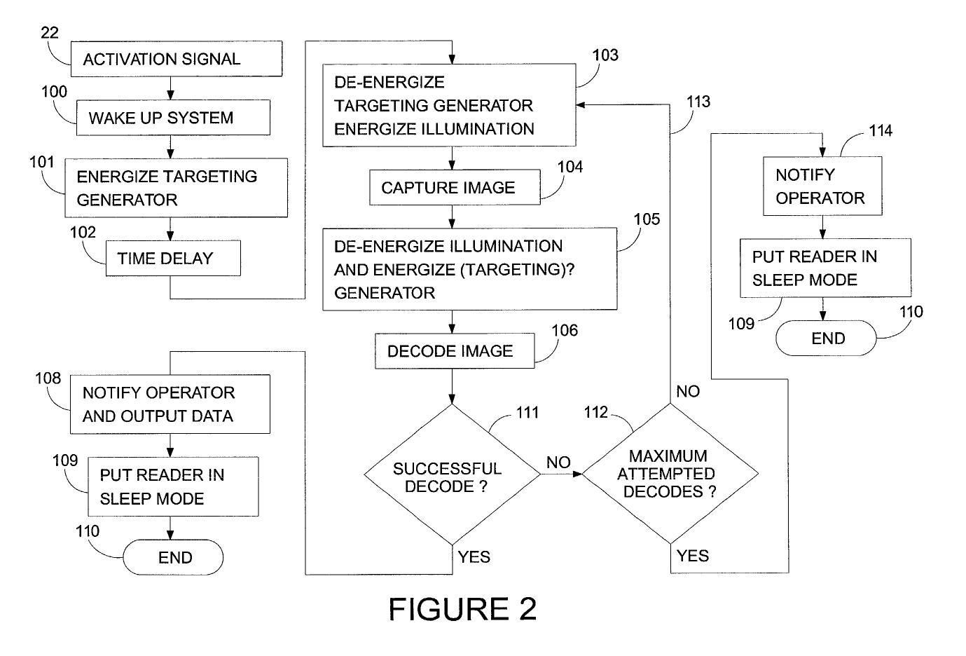

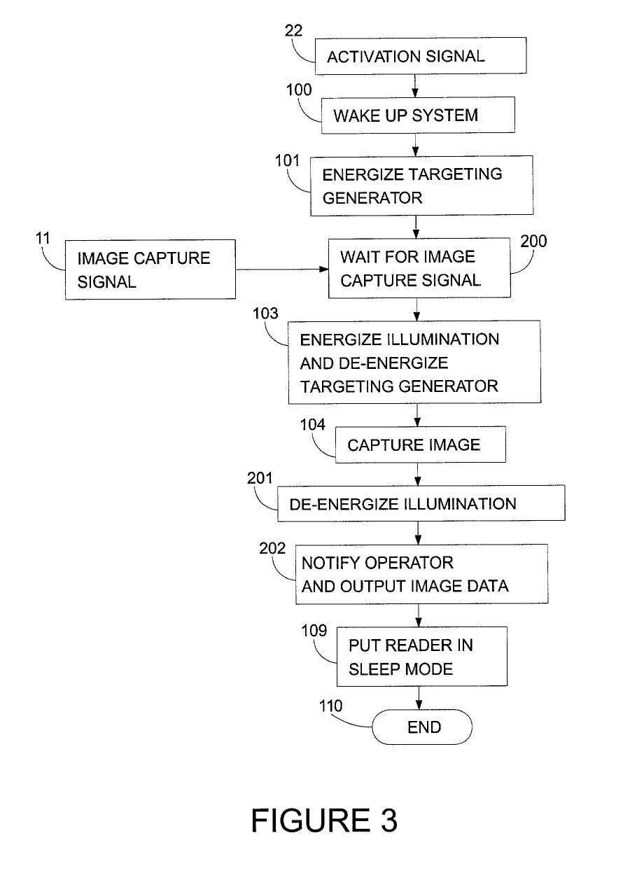

A controller 17 coordinates the functional components of the reader 1 via communication paths 18, 19, 20 and 21. The controller 17 responds to an activation command signal 22 to start the sequence of events as described with regard to FIG. 2 and FIG. 3 to capture an image and to a state changer to control the reader 1 for capturing and reading a symbology (FIG. 2) or for simply capturing an image (FIG. 3).

Turning first to the sequence of steps to read a symbology shown in the flow chart in FIG. 2. The activation signal 22 changes the state of the reader 1 from a reduced power consumption mode, referred to as a sleep mode, to a normal operating mode as shown in the wake up system step 100. By way of example the activation signal 22 can be provided by an operator using a switch or trigger mechanism or could be provided remotely by a host system.

When the reader 1 has been put into its normal operating mode the targeting generator 3 is energized in step 101. The energized targeting generator 3 projects a pattern onto the target 2 to ensure that the reader 1 is an acceptable distance from the target 2 as further detailed in the discussion of FIGS. 4 to 7. The projected patterns may also aid an operator in aligning the reader 1 with the desired target 2. A time delay 102 may be introduced to allow an operator a period of time to align the reader 1 with the target 2 before the reader 1 captures an image and attempts to decode a symbology in the image. Alternately, an operator controlled image capture signal 11 may be used to initiate the next step rather then the time delay 102, or the next step may be taken immediately after step 101.

After the time delay 102, the targeting generator 3 energized in step 101 is de-energized and the illumination system 5 is energized in step 103. With the targeting generator 3 de-energized, the illumination provided by the illumination system 5 that was energized in step 103 is more uniform over the target 2. The combination of the illumination from the reader 1 and ambient light sources external to the reader 1 provides sufficient light for capturing an image of the target 2. With the target 2 illuminated, an image of the target 2 is captured in the capture image step 104.

After the image has been captured, the illumination source 5 is de-energized and the targeting generator 3 is energized in step 105. This allows an operator to continue aligning the reader 1 with the target 2 using the projected pattern. In the event that the symbology in the captured image cannot be decoded, corrections made by the operator to the alignment between the reader 1 and the target 2 may assure the availability of a better image in the next attempt at decoding the symbology.

While an operator continues to align the reader 1 with the target 2, the image is decoded in step 106. If the symbology is correctly decoded then the operator is notified and the decoded data is transferred to the host system in step 108 By way of example, the operator can be notified using an audio tone or a coloured light. The reader 1 is then put into a reduced power consumption mode in step 109 and the sequence ends at step 110.

If the decoding in step 106 is unsuccessful, decision step 111, and the number of decoding attempts has not exceeded a predetermined maximum number, decision step 112, then the capture and decoding sequence restarts by returning to step 103 along path 113. If the decoding in step 106 is unsuccessful and the number of decoding attempts has exceeded the maximum number then the operator is notified in step 114, the reader 1 is put into a reduced power consumption mode in step 109 and the sequence ends at step 110. The maximum number of decoding attempts can be set to meet the requirements of a system along with operator preference.

The sequence of events to read a symbology as detailed above in relation to FIG. 2 is given by way of example. A number of variations may be made to the process outlined. For instance, the reader 1 may not include a reduced power consumption mode, which would remove steps 100 and 109. The time delay step 102 may be omitted. The targeting generator 3 may remain energized during the entire process until step 108, altering steps 103 and 105. Also, the reader 1 may rely entirely on ambient light sources, which also would alter steps 103 and 105. The reader 1 may also be operated such that decoding will automatically be reattempted until such time that the operator decides to abandon the attempts to decode the symbology. In such a scenario, decision step 112 is replaced by a decision step to continue attempts or not and step 114 is removed.

Turning now to FIG. 3, which shows the flow chart of the sequence of steps when reader 1 is being used to simply capture an image of a target 2. Steps that are similar to those in the FIG. 2 flow chart have similar reference numbers. The activation signal 22 takes the reader 1 out of a reduced power consumption mode in the wake up system step 100 then energizes the targeting generator 3 in step 101. The energized targeting generator 3 projects a pattern onto the target 2 to ensure that the reader 1 is an acceptable distance from the target 2 as further detailed in the discussion of FIGS. 4 to 7. The projected patterns may also aid an operator in aligning the reader 1 with the desired target 2. Reader 1 then waits for the operator controlled image capture signal 11 in step 200. This allows an operator to correctly align the reader 1 with the target 2 using the targeting generator 3 and, when correctly aligned, the operator can initiate the capture of the image using the image capture signal 11. By way of example, the image capture signal 11 can be implemented using a second position in a trigger that also provides the activation signal 22 or can be implemented using a second trigger or switch.

When the image capture signal 11 is activated, the illumination source 5 is energized and the targeting generator 3 is de-energized in step 103. The image is then captured in step 104 and the illumination source 5 is de-energized in step 201. The operator is then notified of the completed operation and the image is transferred to the host system in step 202. The reader 1 is then put back into a sleep mode in step 109 and the sequence ends at step 110.

The process described above with reference to FIG. 3 is given by way of example. As was described with regard to the FIG. 2 process, variations to the process in FIG. 3 are also possible. For instance, the targeting generators 3 may remain energized during image capture, which would modify step 103; the image capture signal 11 may be provided following a given time delay after the activation signal 22, or only ambient light sources might be used to illuminate the target 2, which would modify steps 103 and 201.

FIG. 4 schematically illustrates a sectional view of a targeting generator 300 in accordance with the present invention which projects a pattern that is substantially in focus within the depth of field 301. The targeting generator 300 comprises a laser diode 302 and an optical element 303 both of which are fixedly mounted within the reader 1 along an optical axis 304. The optical axis 304 extends beyond the optical element 303 to a target 2 that is external of the reader 1.

The laser diode 302 provides a coherent source of light in the visible wavelength that is substantially collimated and is directed along the optical axis 304 to the optical element 303. A laser diode 302 is shown by way of example, however a low-power helium-neon (HeNe) laser can also provide a suitable collimated, coherent light source. In this particular embodiment, the optical element 303 is a hybrid optical element and includes a spherical lens 306 combined with a diffractive optical element 305 formed on a surface of lens 306. Element 303 is mounted within the reader 1 such that the beam emitted from the laser diode 302 hits diffractive optical element 305 perpendicularly.

The diffractive optical element 305 of the optical element 303 is designed to modify the collimated beam from the collimated light source 302 to produce a beam having a two-dimensional pattern using diffractive optics. The diffractive optical element 305 operates by splitting the beam into many smaller beams which then recombine and through interference between the beams, the two-dimensional pattern is produced. This is a well known technology to those skilled in the art and well known methods currently exist to design the diffractive optics to produce a desired two-dimensional pattern as can be seen from the textbook entitled Micro-Optics-Elements, Systems and Applications published by Taylor and Francis Ltd. in 1997, and in particular in Chapter 1, pages 1-29—Design of Refractive and Diffractive Micro-optics by H. P. Herzig which is incorporated herein by reference. By way of example, the pattern created by the diffractive optics could be a solid arrow, a solid cross, a solid rectangle, a hollow circle, a horizontal line with a vertically elongated diamond in the centre of the line or some other similar pattern to aid the user.

Lens 306 of the optical element 303 is a fresnel lens consisting of a series of concentric circular grooves formed on a flat surface to replace the curved surface of a conventional lens. The grooves act as refracting surfaces and bend parallel rays of light to a common focus. A fresnel lens 306 combined in a hybrid optical element 303 with the diffractive optical element 305 is chosen by way of example because it is small and easy to manufacture. Other configurations can provide the same optical function. In another configuration the lens 306 of the optical element 303 could use a conventional lens or the optical element 303 can be separated into two components, the diffractive optical element providing the beam splitting function and the other providing the focusing function using either a fresnel lens or conventional lens.

The fresnel lens 306 is designed to project the pattern along the optical axis 304 such that it appears in focus to a typical operator when projected on a surface that lies in a range 301 of distances from the lens 306 of the optical element 303. The range 301 of distances extends from a plane 307 located at a minimum distance D1 from the lens 306 to a plane 308 located at a maximum distance D2, from the lens 306. When the pattern is projected onto a surface that does not lie between the minimum D1 and maximum D2 distances then the pattern appears discernibly out of focus to a typical operator.

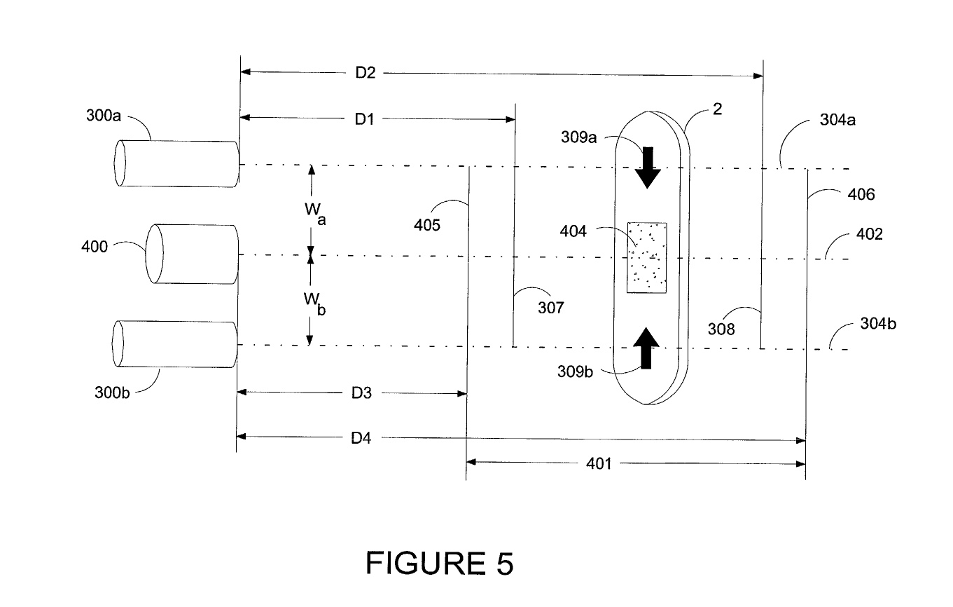

FIG. 5 schematically illustrates the preferred embodiment configuration of targeting generators within a reader 1. In this embodiment, targeting generators 300a and 300b are aligned on either side of the imaging component 400 of the reader 1. The components 300a, 300b and 400 are all fixed within the reader 1 and are all pointed towards a target 2 including a symbology 404. The three components 300a, 300b and 400 are in a single plane with the first targeting generator 300a a distance Wa from the imaging component 400 and the second targeting generator 300b a distance Wb on the other side of the imaging component 400. In order to more easily align the imaging component 400 with the target 2, it is preferred that Wa and Wb be equal. The optical axis 304a of the first targeting generator 300a and the optical axis 304b of the second targeting generator 300b are coplanar with and parallel to the optical axis 402 of the imaging component 400. The optical axis 402 of the imaging component 400 is the centre of the image captured by the imaging component 400.

The first targeting generator 300a projects a pattern 309a onto a target 2 and the second targeting generator 300b projects a pattern 309b onto the target 2. The patterns 309a and 309b are shown as arrows pointed towards each other but may be other shape such as a horizontal line with a vertically elongated diamond in the centre of the line, a solid cross, a solid rectangle or a hollow circle. The targeting generators 300a and 300b are designed to be substantially the same such that both patterns 309a and 309b appear to a typical operator to be substantially in focus when the target 2 is within the depth of field 301 between distances D1 and D2 from the targeting generators 300a and 300b.

The imaging component 400 of the reader comprises a focusing system 8 in and an imager 10 as shown in FIG. 1, and has its light receiving opening pointing along optical axis 402 towards the target 2. The other components of the reader 1 are not shown. The reader 1 is designed such that a symbology 404 can be successfully read when it is located in a range 401 of distances from the imaging component 400 that extends from a minimum distance D3 to a maximum distance D4. This means that when the target 2 is placed between the plane 405 at a minimum distance D3 from the reading component 400 and the plane 406 at a maximum distance D4 from the reading component 400 then the symbology 404 can be successfully read as a result of the depth of field of the optics as well as the ability of the image processing and decoding circuitry 15 to decode a slightly out of focus image. This range 401 of distances, which allows a successful reading of a symbology 404, is referred to as the depth of reading 401 of the reader 1. It should be noted in FIG. 5 that the range of distances that targeting patterns 309a and 309b appear in focus to a typical operator lie within the depth of reading 401 of the reader 1. It is further to be noted that the target may include a picture with the symbology 404 imbedded in it.

The depth of reading 401 of the reader 1 is determined by the design of the focusing system 8, imager 10 and image processing and decoding circuitry 15 of the reader 1 that have all been previously described with reference to FIG. 1. It is more desirable to have a longer depth of reading 401 but due to other design criteria for the reader 1, the depth of reading 401 is limited. Using a smaller aperture can extend the depth of reading 401 but this reduces the available light for the imager 10; a more complex, adjustable focusing system 8 may also be used. Typically, the symbology 404 can be read even when the image of the target 2 is a small amount out of focus due to functions performed by the image processing and decoding circuitry 15 in FIG. 1. This characteristic of the present invention is particularly advantageous since the operator is able to determine whether the symbology is within the depth of reading 401 of the reader to a sufficient degree to provide an acceptable image for processing.

In FIG. 6, the optimal alignment between the imaging component 400 and the target 2 is shown by the projected patterns 309a and 309b next to the symbology 404 on the target 2. The optical axis 402 of the imaging component 400 is at the centre of the symbology 404. The distance between the imaging component 400 and the target 2 is within the depth of reading 401 of the reader 1 since the projected patterns 309a and 309b are observed to be in focus by an operator. The horizontal centreline 408 of the symbology 404 is aligned with the centre of the projected patterns 309a and 309b ensuring that the symbology 404 is vertically centred with the reader 1. The projected patterns 309a and 309b are equally spaced on both sides of the symbology 404 ensuring that the vertical centreline 409 of the symbology 404 is on the optical axis 402 of the reader 1. It is typically not necessary to place the centre of the symbology 404 at the centre of the captured image shown by the optical axis 402 in order to successfully decode a symbology 404 but identifying the optical axis 402 of the reader 1 will aid an operator in aligning the reader 1 with the symbology 404. It is also typically faster to decode a symbology 404 that is not rotated about the optical axis 402 of the reader 1 with respect to the reader 1.

Though FIG. 5 has been described as the preferred embodiment, variations on the configuration can be made, which would result in arrangements having an equivalent functionality. For instance, the targeting generators 300a and 300b could be located closer to the target 2 than the imaging component 400, they may be located on another plane parallel to the plane currently defined by optical axes 304a, 304b and 402 or the projected patterns 309a and 309b may be different from each other. Also, targeting generator 300b can be omitted leaving a single projected pattern 309a or additional targeting generators could be added. A single generator configuration will not provide as much information to an operator in the relative alignment between the reader 1 and the symbology 404 but in some applications this can be a beneficial trade-off for the reduced complexity, power consumption and size of a second targeting generator 300b.

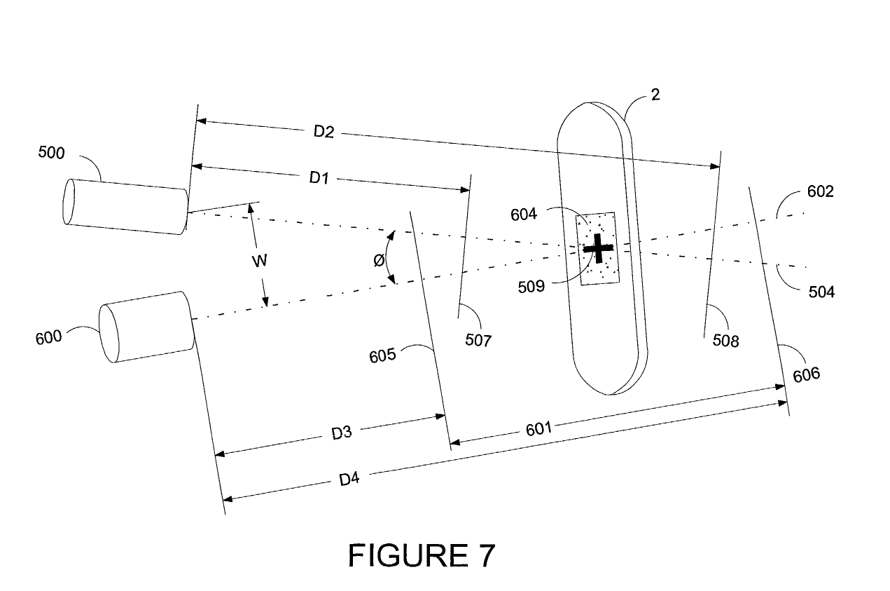

In a second embodiment of the invention as shown in FIG. 7, the reader 1 has only one targeting generator 500 fixedly mounted in the reader 1 next to the imaging component 600. The targeting generator 500 has an optical axis 504 along which a pattern 509 is projected. The imaging component 600 has an optical axis 602 that lies in the same plane as the optical axis 504 of the targeting generator 500 and the two axes intersect at a point due to the angle φ between the axes 504 and 602.

As in the previous embodiment, the targeting generator 500 projects a pattern 509 onto a target 2 and the pattern 509 appears in focus to a typical operator when the target 2 lies between the distances D1 and D2 from the targeting generator 500, which is within the depth of reading 601 of the reader 1. The depth of reading 601 is the range between D3 and D4, the minimum and maximum distances from the imaging component 600.

In FIG. 7, the pattern 509 projected onto the target 2 is shown by way of example as a cross, however other patterns such as a horizontal line with a vertically elongated diamond in the centre of the line, a solid rectangle or a solid arrow can provide the same function. The symbology 604 is shown to be at the intersection of the targeting generator 500 optical axis 504 with the optical axis 602 of the imaging component 600 and is in the middle of the range of reading 601 of the reader 1 that is the optimal location for reading a symbology 604. When the symbology 604 is at this point the projected pattern 509 lies at the centre of the image taken by the imaging component 600 but when the symbology 604 is not at this position then the projected pattern 509 does not lie on the optical axis 602 of the reader 1. The configuration is designed such that the distance W that separates the targeting generator 500 from the imaging component 600 is small relative to the distance D3 and hence the projected pattern 509 moves a relatively small distance from the optical axis 602 of the reader 1 as the target 2 moves throughout the depth of reading 607 of the reader 1.

In the same manner to the operation of the preferred embodiment in FIG. 5, the projected pattern 509 shows an operator the relative location and rotational orientation of the symbology 604 compared to the imaging component 600.

The preferred embodiment shown in FIG. 5 and the second embodiment shown in FIG. 7 both are able to successfully read a symbology 404. When a reader 1 is used for capturing and outputting an image as shown in the process described with regard to FIG. 3, the same target 2 alignment requirements are needed to produce an image that is sufficiently well focused. For this reason the targeting generator 300a, 300b and 500 configurations shown in FIGS. 5 and 7 respectively can be used to capture images of a variety of targets as well as reading a symbology.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. An optical reader for collecting image data representative of light reflected from a target, said reader comprising:
imaging means having a photosensitive detector for producing image data signals from light reflected by the target and means for focusing the reflected light onto the photosensitive detector from the target located within a depth of reading range of the imaging means, and
targeting generator means for generating an illuminated pattern on the target such that the pattern appears substantially in focus on the target located over a range of distances from the generator means within the depth of reading range of the imaging means.

2. An optical reader as claimed in claim 1 which further comprises host connection means for receiving the image data signals for transfer to a host system.

3. An optical reader as claimed in claim 1 which further comprises image processing means for receiving the image data signals and decoding information contained in the image.

4. An optical reader as claimed in claim 3 wherein the image contains a symbology

5. An optical reader as claimed in claim 4 which further comprises host connection means for receiving the symbology decoded information for transfer to a host system.

6. An optical reader as claimed in claim 1 which further comprises illumination means for illuminating the target area.

7. An optical reader as claimed in claim 1 which further comprises:
host connection means for receiving the image data signals for transfer to a host system;
illumination means for illuminating the target area;
means for controlling the imaging means, the target generator means, the host connection means and the illumination means.

8. An optical reader as claimed in claim 7 wherein the controller means is adapted to receive an activate command signal to activate the optical reader and to receive an image capture command signal to activate the imaging means.

9. An optical reader as claimed in claim 1 which further comprises:
image processing means for receiving the image data signals and decoding information contained in the image;
illumination means for illuminating the target area;
means for controlling the imaging means, the target generator means, the image processing means and the illumination means.

10. An optical reader as claimed in claim 9 wherein the controller means is adapted to receive an activate command signal to activate the optical reader.

11. An optical reader as claimed in claim 1 wherein the targeting generator means comprises one or more targeting generators fixedly mounted about the imaging means wherein each targeting generator is adapted to project a predetermined pattern along an optical axis.

12. An optical reader as claimed in claim 11 wherein two targeting generators are mounted about the imaging means such that the optical axes of the targeting generators are parallel and coplanar with the optical axis of the imaging means.

13. An optical reader as claimed in claim 11 wherein one targeting generator is mounted about the imaging means such that the optical axis of the targeting generator is parallel to the optical axis of the imaging means.

14. An optical reader as claimed in claim 11 wherein one targeting generator is mounted about the imaging means such that the optical axis of the targeting generator intersects the optical axis of the imaging means in the depth of reading range of the imaging means.

15. An optical reader as claimed in claim 11 wherein targeting generator comprising:
light source means for producing a coherent beam;
diffractive surface means for producing a pattern from the coherent beam; and
focusing means for focusing the pattern in the depth of reading range of the imaging means.

16. A targeting generator as claimed in claim 15 wherein the diffractive surface means comprises a diffractive optical element.

17. A targeting generator as claimed in claim 15 wherein the focusing means comprises a fresnel lens.

18. A targeting generator as claimed in claim 17 wherein the diffractive surface means comprises a diffractive optical element on the surface of the fresnel lens facing the light source means.

19. A targeting generator as claimed in claim 15 wherein the light source means is a laser diode.

20. A targeting generator as claimed in claim 19 wherein the light source means is a HeNe laser.

21. A reader as claimed in claim 1 wherein the photosensitive detector includes charge coupled devices.

22. A reader as claimed in claim 1 wherein the photosensitive detector includes complementary metal oxide silicon devices.

23. A method of sensing and collecting optical image data of a target using a reader having imaging means with a predetermined depth of reading range comprising:
a. projecting one or more illuminated patterns on the target wherein the pattern is substantially in focus at a distance within the predetermined depth of reading range;
b. adjusting the distance between the reader and the target until the pattern is substantially in focus; and
c. capturing the image of the target.

24. A method as claimed in claim 23 wherein step b. further includes adjusting the rotational position of the reader with respect to the target.

25. A method as claimed in claim 24 wherein step a. includes projecting the one or more patterns equally spaced about the imaging means optical axis.

26. A method as claimed in claim 24 wherein step a. includes projecting a pattern on the imaging means optical axis.

27. A method as claimed in claim 24 wherein the target is a symbology.

28. A method as claimed in claim 24 wherein the target is a picture with a symbology embedded therein.

29. A method as claimed in claim 24 wherein the target is a one-dimensional symbology.

30. A method as claimed in claim 24 wherein the target is a two-dimensional symbology.

31. A method as claimed in claim 24 wherein the pattern may be selected from arrows, rectangles, crosses and circles.

32. A method as claimed in claim 24 wherein the pattern is a horizontal line with a vertically elongated diamond at its centre.

33. A method of sensing and collecting optical image data of a symbology using a reader having imaging means with a predetermined depth of reading range, targeting generator means for projecting one or more illuminated patterns on the target wherein the pattern is substantially in focus at a distance within the predetermined depth of reading range of the imaging means, image processing means for receiving the symbology optical image data and decoding information contained in the symbology, host connection means for receiving the decoded information for transfer to a host system, target illumination means, and a controller for controlling the imaging means, the target generator means, the image processing means and the illumination means, comprising the steps of:
a. energizing the targeting generator means;
b. adjusting the reader position;
c. capturing the symbology image; and
d. decoding the symbology image.

34. A method as claimed in claim 33 wherein step b. further includes:
b.1. illuminating the symbology.

35. A method as claimed in claim 33 wherein step b. further includes:
b.1. de-energizing the targeting generator means; and
b.2. illuminating the symbology.

36. A method as claimed in claim 33 wherein steps a. to d. are repeated until the symbology is successfully decoded.

37. A method as claimed in claim 36 wherein step d. further includes:
d.1. sending the successfully decoded symbology information to the host connection means for transfer.

38. A method of sensing and collecting optical image data of a target using a reader having imaging means with a predetermined depth of reading range, targeting generator means for projecting one or more illuminated patterns on the target wherein the pattern is substantially in focus at a distance within the predetermined depth of reading range of the imaging means, host connection means for receiving the image data for transfer to a host system, target illumination means, and a controller for controlling the imaging means, the target generator means and the illumination means, comprising the steps of:
a. energizing the targeting generator means;
b. adjusting the reader position;
c. capturing the target image; and
d. sending the image data to the host connection means for transfer.

39. A method as claimed in claim 38 wherein step b. further includes:
b.1. illuminating the target.

40. A method as claimed in claim 38 wherein step b. further includes:
b.1. de-energizing the targeting generator means; and
b.2. illuminating the image.

41. A method as claimed in claim 38 wherein step b. further includes:
b.1. initiating the image capture;
b.2. de-energizing the targeting generator means; and
b.3. illuminating the image.

42. An optical reader for collecting image data of a target, said reader comprising:
imaging means having a photosensitive detector for producing image data signals from light reflected by the target and means for focusing the reflected light from the target onto the photosensitive detector, and
targeting generator means adapted to project a substantially in focus illuminated pattern onto the target when located at a predetermined range of distances from the target for positioning the optical reader relative to the target.

43. An optical reader as claimed in claim 42 wherein the imaging means has a predetermined depth of reading range and wherein the illuminated pattern is substantially in focus when the target is located within the predetermined depth of reading range.

44. An optical reader as claimed in claim 43 which further comprises image processing means for receiving the image data signals and decoding information contained in the image.

45. An optical reader as claimed in claim 44 wherein the predetermined depth of reading range is determined by the focusing means and the image processing means.
